(19) United States
(12) Patent Application Publication
(10) Pub. No.: US 2009/0271446 A1
(43) Pub. Date: Oct. 29, 2009

(54) METHOD AND SYSTEM FOR MODIFICATION OF AN UNLOCKED RECORD OF A DATABASE BY INTERACTING PROCESSES

(75) Inventor: Frederic Depreter, Le Roeulx (BE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/430,391

(22) Filed: Apr. 27, 2009

(30) Foreign Application Priority Data
Apr. 25, 2008 (EP) 08007980.9

(51) Int. Cl. G06F 12/00; G06F 17/30

(52) U.S. Cl. 707/201; 707/8; 707/200; 707/E17.005; 711/E12.001

(57) ABSTRACT

In a method for modifying an unlocked record of a database by interacting processes, a first process accesses the record and locks it, then checks if the record is marked for post-processing. In case the record is not marked for post-processing the first process proceeds to the following actions: performs the operations on the record, unlocks the record and terminates. In case the record is marked for post-processing the first process performs the following steps: sets the flag to a predefined first state which denotes that post-processing is due, performs the operations to the record and saves them, unlocks the record, calls a second process and terminates. In the case that the record is marked for post-processing, the second process performs the following steps: performs further operations to the record and saves them, sets the flag to a predefined second state which denotes that post-processing is done and terminates.

### CROSS-REFERENCE TO RELATED APPLICATION

This application claims the priority, under 35 U.S.C. §119, of European application EP 08 007 980.9, filed Apr. 25, 2008; the prior application is herewith incorporated by reference in its entirety.

### BACKGROUND OF THE INVENTION

### Field of the Invention

The invention relates to a method and system for modification of an unlocked record of a database by interacting processes, especially in a case that the interacting processes are a foreground and a background process.

Commonly used database systems like ORACLE and MS-SQL SERVER are based on row-locking, meaning that a record is locked while being used by a process for data transaction. However, the lock is guaranteed only for the time of the transaction. At the end of the transaction, the lock status disappears. Some systems provide a feature to create user locks, however the systems lack the possibility to share a lock between a foreground and a background process. This possibility would be very useful in certain use cases in order to avoid unwanted modifications to a record in the time between the release of the record by the foreground process and the locking of the record by the background process.

### SUMMARY OF THE INVENTION

It is accordingly an object of the invention to provide a method and a system for modification of an unlocked record of a database by interacting processes that overcomes the above-mentioned disadvantages of the prior art methods of this general type.

With the foregoing and other objects in view there is provided, in accordance with the invention, a method for modifying an unlocked record of a database by interacting processes. The method includes the steps of:

a) performing a first process which accesses a record and locks the record in order to perform operations to the record;

b) checking during the first process if the record is marked for post-processing by detecting a presence of a flag in the record;

c) performing, via the first process, the following actions in a case the record is not marked for post-processing and thus a presence of the flag is lacking:
performing the operations on the record;
unlocking the record and terminating the first process;

d) performing, via the first process, the following steps in a case the record is marked for post-processing and thus a presence of the flag is detected:
setting the flag to a predefined first state which denotes that post-processing is due;
performing the operations to the record and saves the record;
unlocking the record;
calling a second process and terminating the first process;

e) performing, via the second process, the following steps in a case where the record is marked for post-processing:
performing further operations to the record and saving the record; and
setting the flag to a predefined second state which denotes that the post-processing is done and terminating the second process.

For reasons of clarity, the present method is based on the assumption that the record is initially not locked. In the case of a locked record, the method is the same, except that a waiting cycle would be entered by a first process described further below, until the record is released.

### EXAMPLE

It is assumed that a person is requesting a reservation for a seat in a plane, the reservation is transferred to a main system for confirmation of the seat. The person chooses a vegetarian meal being at a third position in a meal list, the choice being handled by the first process, the choice then is submitted by a second process to a catering service. It is further assumed that an action consists in an update of the choice of meals presented to the person by a process. In a use case, it is assumed that an action is carried out immediately after the person has chosen the meal preference.

Other features which are considered as characteristic for the invention are set forth in the appended claims.

Although the invention is illustrated and described herein as embodied in a method and a system for modification of an unlocked record of a database by interacting processes, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a process of record modification in a standard database system according to the invention;

FIG. 2 is an illustration showing the process of record modification in a case of two interacting processes in a standard database system;

FIG. 3 is an illustration showing the process of record modification in a standard database system applied to the example;

FIG. 4 is an illustration showing a record modification using the present solution applied to the example; and

FIG. 5 is a flow chart of the record modification using the present solution.

### DETAILED DESCRIPTION OF THE INVENTION

All horizontal arrows in the figures denote a same time base of processes.

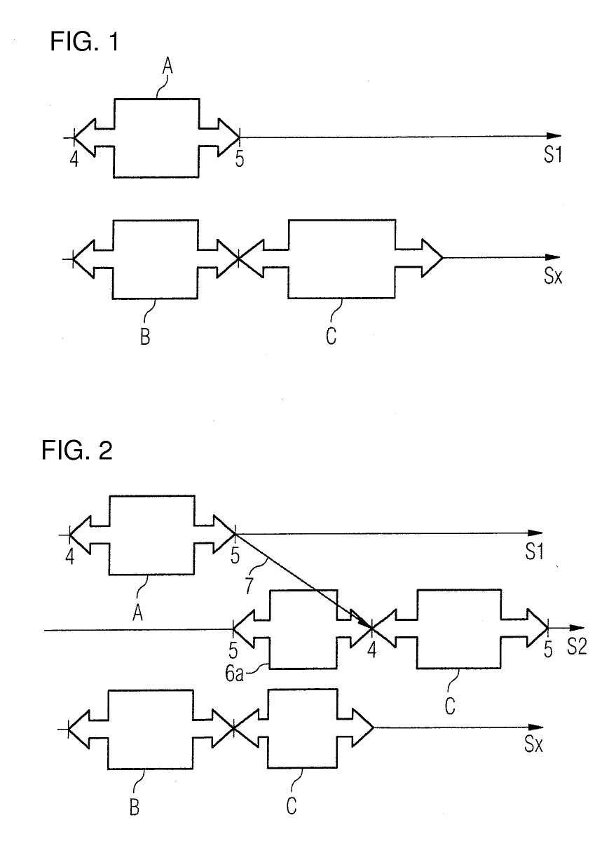

FIG. 1 shows the principle of record modification in a standard database system. A record modification A by process S1 starts with locking 4 the record before the modification A and releasing 5 the record after the modification A. In the timeframe between 4 and 5 no modification B of the record by the process Sx is possible. After releasing 5 the record, the process Sx has access to the record in order to modify it C.

FIG. 2 shows the principle of record modification in a case of two interacting processes in a standard database system. A record modification A by the process S1 starts with locking 4 the record before the modification A and releasing 5 the record after the modification A. In the timeframe between 4 and 5 no modification B of the record by the process Sx is possible. After releasing the record, the first process S1 wakes up 7 the second process S2. However, the time until the second process S2 comes to action in order to modify D the record, there is a lock gap 6a of the record. In this period of time, a record modification C by Sx is possible.

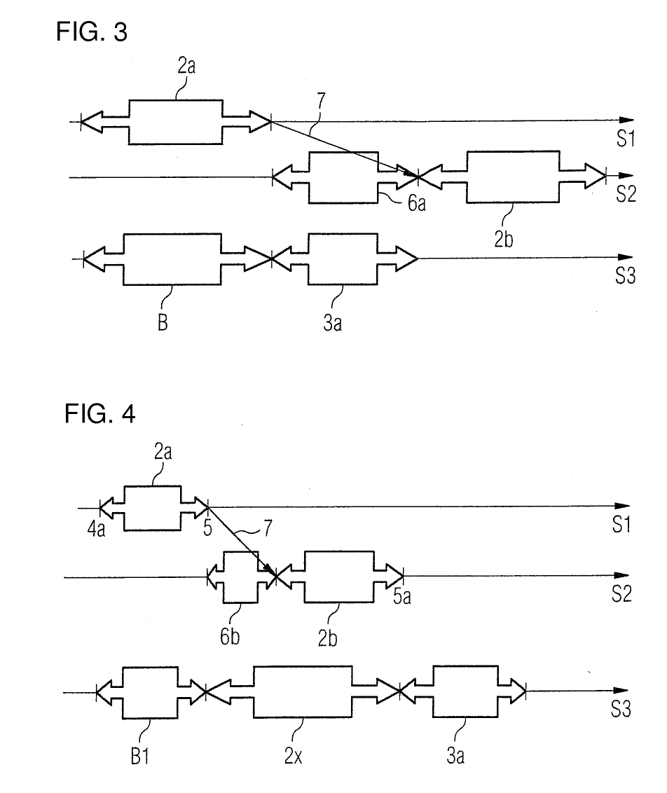

FIG. 3 shows a record modification in a standard database system applied to the example. After locking 4 the record of the plane ticket reservation, the first process S1 provides the person with a list of meals to choose from. The person chooses 2a the vegetarian meal which is located at the third position of the meal list. The first process S1 then wakes up 7 the second process S2 after unlocking the record, the second process then submits 2b the meal choice to the catering service. However, in the lock gap 6a, as previously explained, there is the possibility for the process S3 to change the record. In this case, the process S3 updates 3a the meal list just before the meal choice is submitted to the catering service, causing the third position of the meal list to be a non-vegetarian meal. As soon as the second process S2 fetches the meal choice data of the record, it will submit the third position of the updated meal list and will thus submit a wrong meal choice.

Thus, standard database systems pose a problem consisting in that the update 3a could change the record before 2b has been executed. A workaround in this case would be to perform the actions 2a and 2b in a same session. However, this has the drawback that a transaction associated with the session would take a long time, meaning that the person would not be able to proceed with further actions until 2b has been completed, thus making this approach highly serial. In case many parameters, like in this example the meal choice, have to be decided upon and transferred or further processed, this serial approach can lead to a considerable amount of time spent with waiting until each of the required actions have been completed.

FIG. 4 shows, in contrast to FIG. 3, a record modification using the present solution, applied to the example. The record contains a post-processing flag, which is modified by the first process S1, whereby the first process S1 contains information to identify a necessity to carry out a post-processing action. If this is the case, it sets the flag to a predefined first state and locks the record 4a, the first state being a value of the flag denoting that post-processing of the record is due. Then the first process S1 provides the person with a list of meals to choose from. The person chooses 2a the vegetarian meal which is located at the third position of the meal list. After the person has chosen the vegetarian meal, the first process S1 unlocks the record and wakes up 7 the second process S2 which then submits 2b the meal choice to the catering service. As the record is still marked for post-processing, thus the flag is in the first state, in other words in a state equivalent to a regular database record lock state, the third process S3 has no possibility to modify 2x the record. Thus, the third process S3 has to wait until the second process S2 has submitted 2b the meal choice and set the flag to a second state, thus releasing the record. After that, the third process accesses the record and changes 3a the meal list.

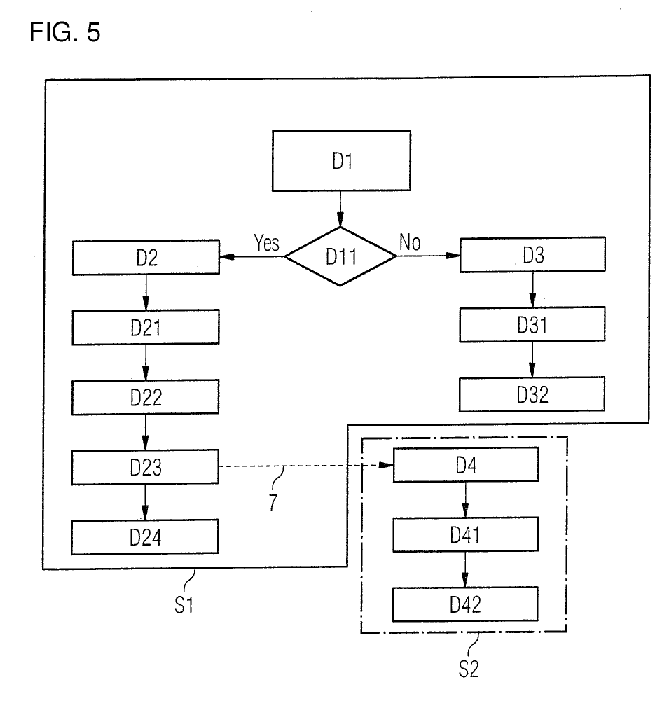

FIG. 5 shows a flow chart of record modification using the present solution. The first process S1 locks D1 the record. After that, S1 checks D11 if the post-processing flag is present. In case the flag is present, S1 sets D2 the flag to the first state, performs D21 operations on the record, unlocks D22 the record, wakes up D23 the second process and terminates D24. If no flag is present, S1 simply performs D3 the operations on the record, unlocks D31 the record and terminates D32. The second process S2 performs further modifications on the record D4, sets D41 the flag to the second state and terminates D42.

One goal to be achieved is to provide a solution which guarantees that a record is locked until both the first process (foreground process) S1 and the second process S2 (background process) have terminated a record access.

One way the goal is achieved is by providing a method and system for modification of an unlocked record of a database by interacting processes, whereby, a first process S1 accesses the record and locks D1 it in order to perform operations to the record. The first process S1 then checks D11 if the record is marked for post-processing by detecting a presence of a flag in the record. In the case that the record is not marked for post-processing, thus the presence of the flag is lacking, the first process S1 proceeds to the following actions:

performs D3 the operations on the record; and

unlocks D31 the record and terminates D32.

In the case that the record is marked for post-processing, thus the presence of the flag is detected, the first process S1 performs the following steps:

sets D2 the flag to a predefined first state which denotes that post-processing is due;

performs D21 the operations to the record and saves them;

unlocks D22 the record; and

calls D23 a second process S2 and terminates D24.

In the case that the record is marked for post-processing, the second process S2 performs the following steps:

performs D4 further operations to the record and saves them; and

sets D41 the flag to a predefined second state which denotes that post-processing is done and terminates D42.

The main advantage of the method is the fact that a high degree of security and reliability in database manipulation is achieved. Another advantage is the fact that the possibility to speed up process execution by parallel actions of multiple processes yields a smaller period of time wherein a record is locked, which in turn leads to an overall improved system efficiency.

The first process S1 is a foreground process and the second process S2 is a background process. A typical use case of the present invention is a setup whereby the first process S1 is a foreground process, meaning that it supports user interaction and the second process S2 is a background process, meaning that no user interaction is required but rather necessary tasks like for example internet communication are carried out. However, the use of the method described herein is not limited to a foreground and a background type of process and/or combination thereof. The advantage is that a high degree of parallelism is achieved. In the example, while the second process S2 is transmitting the meal choice, the person can proceed with a further reservation without having to wait until the first reservation has been submitted.

The first state of the flag is equivalent to a lock state of the record, preventing an access to the record by any arbitrary process Sx other than the second process S2 and the second state of the flag is equivalent to an unlocked state of the record, granting access to the record by any arbitrary process Sx. In other words, existing systems are expanded by a double-locking strategy, which further enhances integrity of records especially during transition phases between processes requesting access to the same record.

The second process S2 is granted the access to the record, the record containing the flag set to the first state, by either being called from within the first process S1 or by inheriting access rights to the record by interprocess communication (IPC). By being called from within the first process S1, the second process S2 implicitly inherits rights to manipulate the record from the first process S1. Another possibility is a transmission of rights to manipulate the record by the procedure of interprocess communication, meaning that data and calls occur between concurrently running threads of different processes. For example this may include remote procedure calls, known as RPC.

The first process S1 applies a change to the flag based on identifying a necessity of calling the second process S2.

A decision of the first process S1 whether the state of the flag has to be changed to the first state is based on information residing in the first process that a second process has to be called. In other words, the first process knows that a background processing has to be carried out, thus, the state of the flag has to be changed. If no other process has to be called from within the first process, the record manipulation is handled in the same way as in a regular database procedure.

A preferred module for implementing the method contains software code, the software code being adapted to be used as a plug-in, the plug-in being importable into database software systems. The module advantageously enhances record manipulation in existing database systems by being loaded as a plug-in, thus, no adaptations have to be carried out to the database system itself.

Another preferred module for implementing the method contains a software library, the software library being adapted to be included into a code base of database software systems. This represents a second alternative of implementing the method described herein. All functions implementing the method described herein are contained in a library, such as a dynamic link library (dll) or a static linked library (lib) which can be included into an existing database system code. The term code base mentioned above refers to a totality of code implementing the entire functionality of a database system. The code base is recompiled in order to take into account the method, yielding a standalone software package which can be deployed in one piece.

1. A method for modifying an unlocked record of a database by interacting processes, which comprises the steps of:
a) performing a first process which accesses a record and locks the record in order to perform operations to the record;
b) checking during the first process if the record is marked for post-processing by detecting a presence of a flag in the record;
c) performing, via the first process, the following actions in a case the record is not marked for post-processing and thus a presence of the flag is lacking:
performing the operations on the record;
unlocking the record and terminating the first process;
d) performing, via the first process, the following steps in a case the record is marked for post-processing and thus a presence of the flag is detected:
setting the flag to a predefined first state which denotes that post-processing is due;
performing the operations to the record and saves the record;
unlocking the record;
calling a second process and terminating the first process;
e) performing, via the second process, the following steps in a case where the record is marked for post-processing:
performing further operations to the record and saving the record; and
setting the flag to a predefined second state which denotes that the post-processing is done and terminating the second process.

2. The method according to claim 1, wherein the first process is a foreground process and the second process is a background process.

3. The method according to claim 1, wherein the predefined first state of the flag is equivalent to a lock state of the record, preventing an access to the record by any arbitrary process other than the second process and the predefined second state of the flag is equivalent to an unlocked state of the record, granting access to the record by any arbitrary process.

4. The method according to claim 3, wherein the second process is granted access to the record, the record containing the flag set to the predefined first state, by either being called from within the first process or by inheriting access rights to the record by means of interprocess communication.

5. The method according to claim 1, which further comprises, applying, via the first process, a change to the flag based on identifying a necessity of calling the second process.

6. A module, comprising:
software code adapted to be used as a plug-in, the plug-in being importable into database software systems, the software code performing a method for modifying an unlocked record of a database by interacting processes, the software code performing the steps of:
a) performing a first process which accesses a record and locks the record in order to perform operations to the record;
b) checking during the first process if the record is marked for post-processing by detecting a presence of a flag in the record;
c) performing, via the first process, the following actions in a case the record is not marked for post-processing and thus a presence of the flag is lacking:
performing the operations on the record;
unlocking the record and terminating the first process;
d) performing, via the first process, the following steps in a case the record is marked for post-processing and thus a presence of the flag is detected:
setting the flag to a predefined first state which denotes that post-processing is due;
performing the operations to the record and saves the record;
unlocking the record;
calling a second process and terminating the first process;
e) performing, via the second process, the following steps in a case where the record is marked for post-processing:
performing further operations to the record and saving the record; and
setting the flag to a predefined second state which denotes that the post-processing is done and terminating the second process.

7. A module, comprising:
a software library, the software library being adapted to be included into a code base of database software systems, the software library performing a method for modifying an unlocked record of a database by interacting processes, the software library performing the steps of:
a) performing a first process which accesses a record and locks the record in order to perform operations to the record;
b) checking during the first process if the record is marked for post-processing by detecting a presence of a flag in the record;
c) performing, via the first process, the following actions in a case the record is not marked for post-processing and thus a presence of the flag is lacking:
performing the operations on the record;
unlocking the record and terminating the first process;
d) performing, via the first process, the following steps in a case the record is marked for post-processing and thus a presence of the flag is detected:
setting the flag to a predefined first state which denotes that post-processing is due;
performing the operations to the record and saves the record;
unlocking the record;
calling a second process and terminating the first process;
e) performing, via the second process, the following steps in a case where the record is marked for post-processing:
performing further operations to the record and saving the record; and
setting the flag to a predefined second state which denotes that the post-processing is done and terminating the second process.
